(19) United States
(12) Patent Application Publication
(10) Pub. No.: US 2007/0299233 A1
(43) Pub. Date: Dec. 27, 2007

(54) Flat Covering Material Consisting Of A Filled Thermoplastic Polyurethane Elastomer

(75) Inventors: Elvio Manso, Giubiasco (CH); Bruno Guidotti, Camorino (CH)

Correspondence Address: OLIFF & BERRIDGE, PLC, P.O. BOX 320850, ALEXANDRIA, VA, 22320-4850, US

(73) Assignee: FORBO-GIUBIASCO SA, Giubiasco (CH)

(21) Appl. No.: 10/586,791

(22) PCT Filed: Feb. 4, 2005
(86) PCT No.: PCT/EP05/01141

§ 371 Date: Aug. 2, 2006

(30) Foreign Application Priority Data
Feb. 9, 2004 (EP) 04002768.2

(51) Int. Cl. E04F 15/10; C08L 75/04

(52) U.S. Cl. 528/59

(57) ABSTRACT

The invention relates to a flat covering material containing a thermoplastic material and filler materials. Said thermoplastic material is a thermoplastic polyurethane elastomer, the quantity thereof amounting to at least 5 wt. % of the entire covering material. The flat covering material is preferably used as a useful covering, especially as a floor covering.

The invention relates to a sheet-like covering material which is intended for floorcoverings and which comprises one or more thermoplastics and one or more fillers.

Sheet-like covering materials which comprise plastic are mainly used in interiors as wallcovering, floorcovering, and functional coverings. They are produced and laid in the form of sheets or webs.

WO 97/42260 describes a sheet-like covering material which comprises a thermoplastic and a flexibilizer, where the flexibilizer encompasses further thermoplastics, polymers, and phthalates. The thermoplastic is an amorphous copolymer of terephthalic acid with ethylene glycol and with a substituted dialcohol. A flexibilizer used, inter alia, was a styrene-butadiene-styrene copolymer (SBS). This covering material described in WO 97/42260 is a good alternative to PVC coverings. However, when the covering material was produced under standard conditions it was found that embrittlement occurs and severely impairs the quality of the final product. In order to circumvent the problem and thus suppress the embrittlement, the process used, although non-aggressive, was extremely complicated and expensive.

Furthermore, materials described in WO 97/42260-paraffin oils and phthalates, which were also used as flexibilizers—have a noticeable adverse effect on the surface of the covering material via migration, also termed exudation. The exudation produced a surface deposit which prevented adhesive bonding with conventional commercially available adhesives. This type of bonding was possible only with specific types. For production of the covering sheets, the starting material is pressed to give a block, which is then cut into layers. In this process it was found that the covering material is particularly susceptible to lasting deformation at the temperatures required for the cutting process.

It was then an object of the present invention to provide a sheet-like covering material which is easy to produce. Furthermore, the intention is that it be resistant to deformation phenomena arising via thermal stress during the cutting process.

The object is achieved via the features as claimed in claim 1. Preferred embodiments of the invention are the subject matter of the dependent claims, to which reference is made here.

A consequence of the content of at least 5% by weight of a thermoplastic polyurethane elastomer is that it is possible to produce sheet-like covering materials on existing plant. The starting materials are pressed to give a block with exposure to heat and this is then cut into layers to give covering sheets. The compression procedure can be carried out in a wide range of Shore D hardness without any embrittlement of the block or of the covering sheets. The additional outlay which is required for non-aggressive processing, and which was required by the presence of the styrene-butadiene-styrene copolymer, can be eliminated. This makes the production process faster and less expensive. By virtue of the properties of the thermoplastic polyurethane elastomer, it is possible to eliminate paraffin oil and phthalates to some extent or entirely. A consequence of this is that exudation of the substances, i.e. migration to the surface of the finished covering sheet, is suppressed.

Surprisingly, it has been found that the block produced with the inventive covering material has very high temperature tolerance for the cutting procedure, because the covering material is deformed reversibly.

The inventive covering material comprises the desired mechanical properties, such as sufficient flexibility and elasticity. Furthermore, walking on the covering material produces no squeaking, and the material is odor-neutral. It is therefore particularly preferably used in interiors, for example in hospitals and in offices.

In one preferred embodiment, the filler present in the sheet-like covering material has been selected from the group of calcium carbonate, coated calcium carbonate, titanium dioxide, aluminum silicate, kaolin, talc, and aluminum hydroxide, and mixtures thereof.

In one particularly preferred embodiment, the sheet-like covering material has not only the thermoplastic polyurethane elastomer and the filler but also at least one further thermoplastic, which has the support function in that it controls the mechanical properties within a wide range of temperature, and which is compatible with the thermoplastic polyurethane elastomer. This thermoplastic is preferably at least to some extent amorphous. An amorphous polycondensate composed of terephthalic acid with two glycols has proven to be particularly suitable, since desired properties in terms of compatibility, mechanical performance, and chemicals resistance have been achieved therewith. The glycols have preferably been selected from the group of ethylene glycol and cyclohexanedimethanol, and similar glycols.

In order to permit better processing of the starting materials and to increase the quality of the final products, auxiliaries can moreover be added to the covering material, examples being lubricants, antistatic agents, UV stabilizers, and mixtures thereof.

Examples of preferred lubricants are calcium stearate, polyesters of long-chain fatty acids, or oleamide. Lubricants based on polymethyl acrylate can also be used.

For better long-term stabilization, UV stabilizers such as sterically hindered amine light stabilizers (HALS) or benzotriazole UV absorbers and phenolic antioxidants have proven to be particularly effective.

In one particularly preferred embodiment, the sheet-like covering material comprises from 5 to 50% by weight of the thermoplastic polyurethane elastomer, up to 25% by weight of the polycondensate of terephthalic acid with ethylene glycol, from 40 to 70% by weight of fillers, and from 1 to 5% by weight of auxiliaries.

In another preferred embodiment, the sheet-like covering material comprises conductive substances. These have been described in EP 0869217, which is incorporated herein by way of reference. Electrically conducting covering materials are particularly suitable for use in laboratories, EDP rooms, and operating theaters.

With use of suitable pigments it is possible to achieve variation of colors and design structures in the covering material in a manner matched to the intended use.

For production of the sheet-like covering material, the polyurethane elastomer and, if appropriate, further thermoplastics, where these can take the form of pellets, chips, or chopped materials, and also fillers, are mixed and are pressed at an elevated temperature. The pellets, chips, or chopped materials have, if appropriate, a conductive coating. Pressing give an approximately homogeneous block. If particles with a conductive coating have been used, the block has uniformly distributed thin conductive layers throughout the block. The block is then split into individual sheets which as a function of the type of use can then be mechanically worked, for example ground. Unlike individual sheets with styrene-butadiene copolymers, whose material sticks to the abrasive paper, resulting in its frequent replacement, the surface of the inventive covering material can be ground with excellent results without adhering of the abrasion paper to the surface. The result is faster mechanical working of the covering material and less frequent interruption of the production process. Since it is possible to use suitable compression parameters for the inventive covering material (for example 25′, 150° C. to 170° C. to 45 bar; 20′, 1000° C.-120° C. at 45 bar), at which the flow behavior of the chipped materials is kept constant during the pressing process in the block, the electrical resistance values achieved for all of the individual sheets conform with specifications. Examples of suitable compression parameters that can be used are the following: 25 minutes at 150°-170° C. and 45 bar, 20 minutes at 100°-120° C. and 45 bar. In one particularly preferred embodiment, the individual sheets are provided with a conductive network print as described in EP-A-0869217.

The inventive covering material can be adhesive-bonded very easily by way of example by commercially available acrylic resin dispersion adhesives. Surprisingly, furthermore, it has been found that the laying of the inventive covering material is substantially independent of the ambient temperature. This means that the covering sheets can be laid without difficulty both in winter and in summer and in a very wide variety of climatic conditions.

The inventive sheet-like covering material is preferably used as functional covering, in particular as floorcovering. However, it can also be used successfully in sports facilities.

### EXAMPLES

The examples below illustrate formulations of the inventive covering material. The covering materials with the formulations of Examples 3 and 7 have proven particularly suitable.

### Example 1

| | Proportion | |
|---|---|---|
| | by weight | % proportion |
| Example 1 | | |
| PETG (Eastar 6763 from Eastman) | 0.0 | 0.0 |
| Thermoplastic polyurethane | 46.9 | 44.0 |
| elastomer (Elastollan type S from | | |
| Elastogran GmbH, composed of a | | |
| polyurethane block (hard segment) | | |
| and of a polyester block (soft | | |
| segment)) | | |
| Filler: calcium carbonate with at | 57.2 | 53.7 |
| least 4.75% of titanium dioxide | | |
| Auxiliaries, such as lubricant | 2.3 | 2.2 |
| (calcium stearate), antistatic | | |
| agent (Statexan from Rheinchemie | | |
| Rheinau GmbH), and UV stabilizer | | |
| (mixture composed of hindered | | |
| amine light stabilizers (HALS) | | |
| and benzotriazole UV absorber | | |
| (Tinuvine grades from Ciba SC)) | | |
| Pigment (color masterbatch | 0.1 | 0.1 |
| pellets) | | |
| Total | 106.5 | 100.0 |
| Shore D 23° C. | | 43 |
| Modulus of elasticity from | | 102 |
| tensile test, 23° C. | | |
| Tensile strain from tensile test, | | 770 |
| 23° C. | | |
| Example 2 | | |
| PETG (Eastar 6763 from Eastman) | 20.4 | 19.2 |
| Thermoplastic polyurethane | 26.5 | 24.9 |
| elastomer (Elastollan type S from | | |
| Elastogran GmbH, composed of a | | |
| polyurethane block (hard segment) | | |
| and of a polyester block (soft | | |
| segment)) | | |
| Filler: calcium carbonate with at | 57.2 | 53.7 |
| least 4.75% of titanium dioxide | | |
| Auxiliaries, such as lubricant | 2.3 | 2.2 |
| (calcium stearate), antistatic | | |
| agent (Statexan from Rheinchemie | | |
| Rheinau GmbH), and UV stabilizer | | |
| (mixture composed of hindered | | |
| amine light stabilizers (HALS) | | |
| and benzotriazole UV absorber | | |
| (Tinuvine grades from Ciba SC)) | | |
| Pigment (color masterbatch | 0.1 | 0.1 |
| pellets) | | |
| Total | 106.5 | 100.0 |
| Shore D 23° C. | | 64 |
| Modulus of elasticity from | | 900 |
| tensile test, 23° C. | | |
| Tensile strain from tensile test, | | 550 |
| 23° C. | | |
| Example 3 | | |
| PETG (Eastar 6763 from Eastman) | 23.0 | 21.6 |
| Thermoplastic polyurethane | 23.9 | 22.4 |
| elastomer (Elastollan type S from | | |
| Elastogran GmbH, composed of a | | |
| polyurethane block (hard segment) | | |
| and of a polyester block (soft | | |
| segment)) | | |
| Filler: calcium carbonate with at | 57.2 | 53.7 |
| least 4.75% of titanium dioxide | | |
| Auxiliaries, such as lubricant | 2.3 | 2.2 |
| (calcium stearate), antistatic | | |
| agent (Statexan from Rheinchemie | | |
| Rheinau GmbH), and UV stabilizer | | |
| (mixture composed of hindered | | |
| amine light stabilizers (HALS) | | |
| and benzotriazole UV absorber | | |
| (Tinuvine grades from Ciba SC)) | | |
| Pigment (color masterbatch | 0.1 | 0.1 |
| pellets) | | |
| Total | 106.5 | 100.0 |
| Shore D 23° C. | | 69 |
| Modulus of elasticity from | | 1300 |
| tensile test, 23° C. | | |
| Tensile strain from tensile test, | | 400 |
| 23° C. | | |
| Example 4 | | |
| PETG (Eastar 6763 from Eastman) | 25.9 | 24.3 |
| Thermoplastic polyurethane | 21.0 | 19.7 |
| elastomer (Elastollan type S from | | |
| Elastogran GmbH, composed of a | | |
| polyurethane block (hard segment) | | |
| and of a polyester block (soft | | |
| segment)) | | |
| Filler: calcium carbonate with at | 57.2 | 53.7 |
| least 4.75% of titanium dioxide | | |
| Auxiliaries, such as lubricant | 2.3 | 2.2 |
| (calcium stearate), antistatic | | |
| agent (Statexan from Rheinchemie | | |
| Rheinau GmbH), and UV stabilizer | | |
| (mixture composed of hindered | | |
| amine light stabilizers (HALS) | | |
| and benzotriazole UV absorber | | |
| (Tinuvine grades from Ciba SC)) | | |
| Pigment (color masterbatch | 0.1 | 0.1 |
| pellets) | | |
| Total | 106.5 | 100.0 |
| Shore D 23° C. | | 71 |
| Modulus of elasticity from | | 1650 |
| tensile test, 23° C. | | |
| Tensile strain from tensile test, | | 270 |
| 23° C. | | |
| Example 5 | | |
| PETG (Eastar 6763 from Eastman) | 0.0 | 0.0 |
| Thermoplastic polyurethane | 31.2 | 30.7 |
| elastomer (Elastollan type S from | | |
| Elastogran GmbH, composed of a | | |
| polyurethane block (hard segment) | | |
| and of a polyester block (soft | | |
| segment)) | | |
| Filler: calcium carbonate with at | 68.1 | 66.9 |
| least 4.75% of titanium dioxide | | |
| Auxiliaries, such as lubricant | 2.3 | 2.3 |
| (calcium stearate), antistatic | | |
| agent (Statexan from Rheinchemie | | |
| Rheinau GmbH), and UV stabilizer | | |
| (mixture composed of hindered | | |
| amine light stabilizers (HALS) | | |
| and benzotriazole UV absorber | | |
| (Tinuvine grades from Ciba SC)) | | |
| Pigment (color masterbatch | 0.1 | 0.1 |
| pellets) | | |
| Total | 101.7 | 100.0 |
| Shore D 23° C. | | 48 |
| Modulus of elasticity from | | 110 |
| tensile test, 23° C. | | |
| Tensile strain from tensile test, | | 880 |
| 23° C. | | |
| Example 6 | | |
| PETG (Eastar 6763 from Eastman) | 17.6 | 17.3 |
| Thermoplastic polyurethane | 18.5 | 18.2 |
| elastomer (Elastollan type S from | | |
| Elastogran GmbH, composed of a | | |
| polyurethane block (hard segment) | | |
| and of a polyester block (soft | | |
| segment)) | | |
| Filler: calcium carbonate with at | 62.2 | 60.2 |
| least 4.75% of titanium dioxide | | |
| Auxiliaries, such as lubricant | 4.2 | 4.1 |
| (calcium stearate), antistatic | | |
| agent (Statexan from Rheinchemie | | |
| Rheinau GmbH), and UV stabilizer | | |
| (mixture composed of hindered | | |
| amine light stabilizers (HALS) | | |
| and benzotriazole UV absorber | | |
| (Tinuvine grades from Ciba SC)) | | |
| Pigment (color masterbatch | 0.1 | 0.1 |
| pellets) | | |
| Total | 101.6 | 100.0 |
| Shore D 23° C. | | 71.5 |
| Modulus of elasticity from | | 890 |
| tensile test, 23° C. | | |
| Tensile strain from tensile test, | | 170 |
| 23° C. | | |
| Example 7 | | |
| PETG (Eastar 6763 from Eastman) | 21.4 | 21.1 |
| Thermoplastic polyurethane | 23.1 | 22.7 |
| elastomer (Elastollan type S from | | |
| Elastogran GmbH, composed of a | | |
| polyurethane block (hard segment) | | |
| and of a polyester block (soft | | |
| segment)) | | |
| Filler: calcium carbonate with at | 52.9 | 52.1 |
| least 4.75% of titanium dioxide | | |
| Auxiliaries, such as lubricant | 4.1 | 4.0 |
| (calcium stearate), antistatic | | |
| agent (Statexan from Rheinchemie | | |
| Rheinau GmbH), and UV stabilizer | | |
| (mixture composed of hindered | | |
| amine light stabilizers (HALS) | | |
| and benzotriazole UV absorber | | |
| (Tinuvine grades from Ciba SC)) | | |
| Pigment (color masterbatch | 0.1 | 0.1 |
| pellets) | | |
| Total | 101.6 | 100.0 |
| Shore D 23° C. | | 68.6 |
| Modulus of elasticity from | | 800 |
| tensile test, 23° C. | | |
| Tensile strain from tensile test, | | 400 |
| 23° C. | | |

1. An approximately homogeneous sheet-like covering material, comprising a thermoplastic and fillers, characterized in that the thermoplastic is a thermoplastic polyurethane elastomer, the amount of which amounts to at least 5% by weight of the entire covering material, and that it comprises in addition to the thermoplastic polyurethane elastomer at least one other thermoplastic which is compatible with the polyurethane elastomer.

2. The sheet-like covering material as claimed in claim 1, where the filler has been selected from the group of calcium carbonate, titanium dioxide, silicates, kaolin, and aluminum hydroxide and mixtures thereof.

3. (canceled)

4. The sheet-like covering material as claimed in claim 1, where the other thermoplastic is amorphous.

5. The sheet-like covering material as claimed in claim 1, where the other thermoplastic present in addition to the thermoplastic polyurethane elastomer is a polycondensates of terephthalic acid with two glycols.

6. The sheet-like covering material as claimed in claim 1, where the other thermoplastic present in addition to the thermoplastic polyurethane elastomer is a polycondensate of terephthalic acid with ethylene glycol and is present in an amount of 25% by weight.

7. The sheet-like covering material as claimed in claim 1, wherein it comprises an auxiliary.

8. The sheet-like covering material as claimed in claim 7, where the auxiliary has been selected from the group of lubricants, antistatic agents, and UV stabilizers, and mixtures thereof.

9. The sheet-like covering material as claimed in claim 2, comprising from 5 to 50% by weight of thermoplastic polyurethane elastomer, from 40 to 70% by weight of fillers, and from 1 to 5% by weight of auxiliaries.

10. A process for production of the sheet-like covering material as claimed in claim 1 via mixing and pressing of the starting material with exposure to heat to give a block and cutting of the block into layers to give the sheet-like covering material.

11. The use of the sheet-like covering material as claimed in claim 1 as floor covering or functional covering.
